(19) United States
(12) Patent Application Publication
(10) Pub. No.: US 2017/0083594 A1
(43) Pub. Date: Mar. 23, 2017

(54) APPLICATION AUTOROUTING FRAMEWORK

(71) Applicant: Microsoft Technology Licesnsing, LLC, Redmond, WA (US)

(72) Inventors: MingChieh Chang, Taipei (TW); Sheng-Yao Shih, Taipei (TW); Yu-Shan Wu, Taipei (TW); Yu-Li Huang, Taipei (TW); ChinNan Lee, Taipei (TW); Mi-Chen Tsai, New Taipei (TW)

(21) Appl. No.: 14/861,457

(22) Filed: Sep. 22, 2015

(51) Int. Cl. G06F 17/30

(52) U.S. Cl. CPC G06F 17/30569; G06F 17/30958; G06F 17/3056

(57) ABSTRACT

Technologies described herein provide application autorouting for converting a data item into a new data format. Technologies described herein include determining a current data format of a data item and a desired data format of the data item. Additionally, technologies described herein further include determining, based at least partly on application information data associated with a plurality of applications, one or more applications of the plurality of applications that, based at least partly on executing the one or more applications in succession, convert the data item from the current data format to the desired data format. Furthermore, technologies described herein include sending the data item and a request to an application of the one or more applications to convert the data item from the current data format to a new data format and receiving a response to the request, the response including the data item in the new data format.

### BACKGROUND

Occasionally, users desire to convert data items into new data formats. For example, a user can desire to convert an audio file to an mp3 file or convert a video file to an mp4 file. Additionally or alternatively, a user can desire to convert a PDF file or an HTML file to a MICROSOFT® WORD® document.

Current techniques enable users to convert data items to new data formats by using applications to convert from a current data format to a desired data format via a single application. That is, current techniques often utilize a single application to perform a direct conversion between data formats.

It is with respect to these and other considerations that the disclosure made herein is presented.

### SUMMARY

Technologies described herein provide application autorouting for converting a data item into a new data format. Technologies described herein include determining a current data format of a data item and a desired data format of the data item. Additionally, technologies described herein further include determining, based at least partly on application information data associated with a plurality of applications, one or more applications of the plurality of applications that, based at least partly on executing the one or more applications in succession, convert the data item from the current data format to the desired data format. Furthermore, technologies described herein include sending the data item and a request to an application of the one or more applications to convert the data item from the current data format to a new data format and receiving, a response to the request, the response including the data item in the new data format. The new data format can be an intermediate data format, prompting additional conversions using one or more additional applications, or the desired data format.

It should be appreciated that the above-described subject matter can be implemented as a computer-controlled apparatus, a computer process, a computing system, or as an article of manufacture such as a computer-readable storage medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing several example components of a system for converting a data item to a new data format utilizing a plurality of applications.

FIG. 2 is a flow diagram illustrating aspects of a method for converting a data item into a new data format utilizing a plurality of applications.

FIG. 3 is a flow diagram illustrating aspects of a method for generating a graph for determining a routing path for converting the data item from a current data format to a desired data format.

FIG. 4 is a flow diagram illustrating aspects of a method for performing a routing path to convert a data item into a new data format in a first mode (i.e., requester mode).

FIG. 5 is a flow diagram illustrating aspects of a method for performing a routing path to convert a data item into a new data format in a second mode (i.e., server mode).

FIG. 6 is a computer architecture diagram illustrating an illustrative computer hardware and software architecture for a computing system capable of implementing aspects of the techniques and technologies presented herein.

FIG. 7 is a diagram illustrating a distributed computing environment capable of implementing aspects of the techniques and technologies presented herein.

FIG. 8 is a computer architecture diagram illustrating a computing device architecture for a computing device capable of implementing aspects of the techniques and technologies presented herein.

### DETAILED DESCRIPTION

The following detailed description is directed to concepts and technologies for utilizing an application autorouting framework to facilitate the conversion of data items into new data formats. For the purposes of this discussion, applications are programs created by programmers to fulfill specific tasks. Non-limiting examples of applications include batch files, scripts (e.g., in a user device or a web service), software components, etc. For example, applications can provide utility, entertainment, educational, and/or productivity functionality to users of devices.

In at least one example, applications described herein can be configured to convert data items into new data formats. For the purposes of this discussion, data items can include data files, streamed data, etc. The concepts and technologies described herein determine routing paths associated with applications and leverage the routing paths for converting data items from a current data format into a desired data format. The concepts and technologies can determine the routing paths and convert the data items without the user having to know how to find a path for converting the current data format to the desired data format. That is, the user can provide a data item in a current data format and the concepts and technologies described herein can output the data item in the desired data format without any additional input from the user.

In some examples, the applications converting the data items between data formats can be executed by a single computing entity. In other examples, the applications can be executed by different computing entities. For the purposes of this discussion, computing entities can correspond to a user device, a cluster of user devices, a cloud, a server, a server cluster, etc.

The technologies described herein include a system including a topology information server and a one or more computing entities. Individual computing entities of the one or more of computing entities can execute one or more applications. Each of the applications of the one or more applications can be configured to convert a data item from a first data format to a second data format. As described below, a computing entity that can execute one or more applications can send application information data to the topology information server when the one or more applications are downloaded onto the computing entity. For each application, the application information data can include data indicating an input data format that the application can read, an output data format that the application can write, and a time associated with converting a data item from the input data format to the output data format.

The topology information server can be configured to receive application information data associated with each of the applications, aggregate the application information data, and send the aggregated application information data to individual computing entities of the one or more computing entities. The aggregated application information data can provide the individual computing entities with an overview of the applications that are available for converting a data item from a current data format to a desired data format. As described below, the aggregated application information data can include application information data associated with various applications. In some examples, converting the data item from the current data format to the desired data format can involve two or more applications and two or more intermediate data formats. In at least one example, at least some of the two or more applications can be associated with different computing entities. In other examples, the two or more applications can be associated with a single computing entity.

In at least one example, the technologies described herein include a first computing entity that can be configured to determine, based at least in part on the application information data, a routing path for converting a data item from a current data format to a desired data format. For the purpose of this discussion, routing paths are determined paths associated with one or more applications, the traversal of which causes a data item in a current data format to be converted into a desired data format.

A second computing entity can be configured to receive a first communication from the first computing entity that includes a first request to convert the data item from the current data format to an intermediate data format and can execute a first application to convert the data item from the current data format to the intermediate data format. In some examples, the second computing entity can send the data item in the intermediate data format back to the first computing entity and the first computing entity can either send a second communication to a different computing entity for converting the data item to the desired data format, or the first computing entity can have an application that can convert the data item to the desired data format. In other examples, the second computing entity can send a second communication to a different computing entity requesting that the different computing entity convert the data item to the desired data format.

As described below, in some examples, a routing path can include a single application that is capable of converting a data item from a current data format to a desired data format. As a non-limiting example, a user can desire to convert a data item that is in a MICROSOFT® WORD® data format to a PDF data format. In such examples, an application accessible by the user (e.g., via a user's computing entity or computing entities communicatively coupled to the user's computing entity) can access the data item in the MICROSOFT® WORD® data format and can convert the data item to a PDF data format.

In other examples, routing paths can include two or more applications that each convert the data item into a new data format such that when the two or more applications are successively executed, the data item can be converted from the current data format to the desired data format. In at least one example, the two or more applications can be executed by a single computing entity.

In other examples, the two or more applications can be executed by different computing entities in a computing environment. As a non-limiting example, a user can desire to translate a data item in English voice data format to Korean voice data format. Neither the user's computing device (e.g., local device) nor computing entities communicatively coupled to the user's computing device (e.g., webservice) can have an application that can read English voice and write Korean voice (i.e., convert English voice to Korean voice). However, the user's computing device can execute an application that can convert English voice data format to English text data format and an application that can convert Japanese text data format to Chinese text data format. A first computing entity communicatively coupled to the user's computing device can execute an application that converts English text data format to Japanese text data format. A second computing entity communicatively coupled to the user's computing device and the first computing entity can execute an application that converts Chinese text data format to Korean text data format and an application that converts Korean text data format to Korean voice data format.

Accordingly, the concepts and technologies described herein can determine a routing path for leveraging applications executed by the user's computing device, the first computing entity, and the second computing entity, to convert the data item from the English voice data format to the Korean voice data format. In the non-limiting example above, the application that can convert English voice data format to English text data format executed by the user's computing device can access the data item in the English voice data format and can convert the data item to an English text data format. The user's computing device can send a request to the first computing entity to convert the data item from the English text data format to a Japanese text data format. The first computing entity can execute the application that can convert the English text data format to the Japanese text data format and can send the data item in the Japanese text data format to the user's computing device to execute the application that can convert Japanese text data format to Chinese text data format. The user's computing device can send the data item in the Chinese text data format to the second computing entity and the second computing entity can execute the application that converts Chinese text data format to Korean text data format and the application that converts Korean text data format to Korean voice data format. The second computing entity can send the data item in the Korean voice data format to the user's computing device.

While the subject matter described herein is presented in the general context of program modules that execute in conjunction with the execution of an operating system and application programs on a computer system, those skilled in the art will recognize that other implementations can be performed in combination with other types of program modules. Generally, program modules include routines, programs, components, data structures, and other types of structures that perform particular tasks or implement particular abstract data types. Moreover, those skilled in the art will appreciate that the subject matter described herein can be practiced with other computer system configurations, including hand-held devices, multiprocessor systems, microprocessor-based or programmable consumer electronics, minicomputers, mainframe computers, and the like.

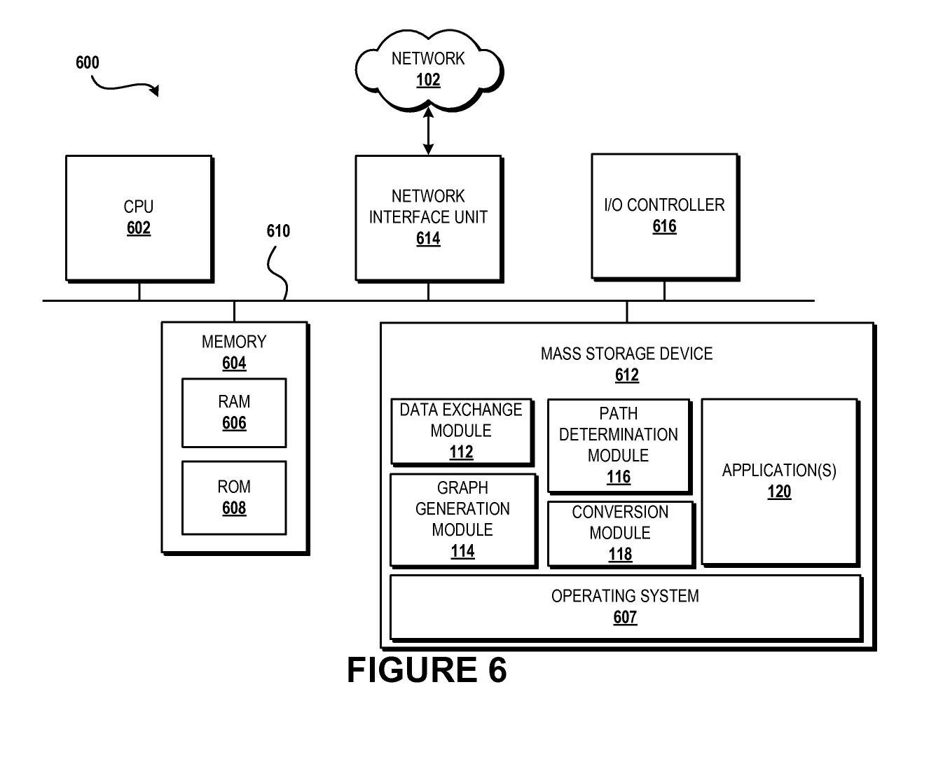

In the following detailed description, references are made to the accompanying drawings that form a part hereof, and in which are shown by way of illustration specific configurations or examples. Referring now to the drawings, in which like numerals represent like elements throughout the several figures, aspects of a computing system, computer-readable storage medium, and computer-implemented methodologies for converting data items into new data formats. As will be described in more detail below with respect to FIGS. 6-8, there are a number of applications and services that can embody the functionality and techniques described herein.

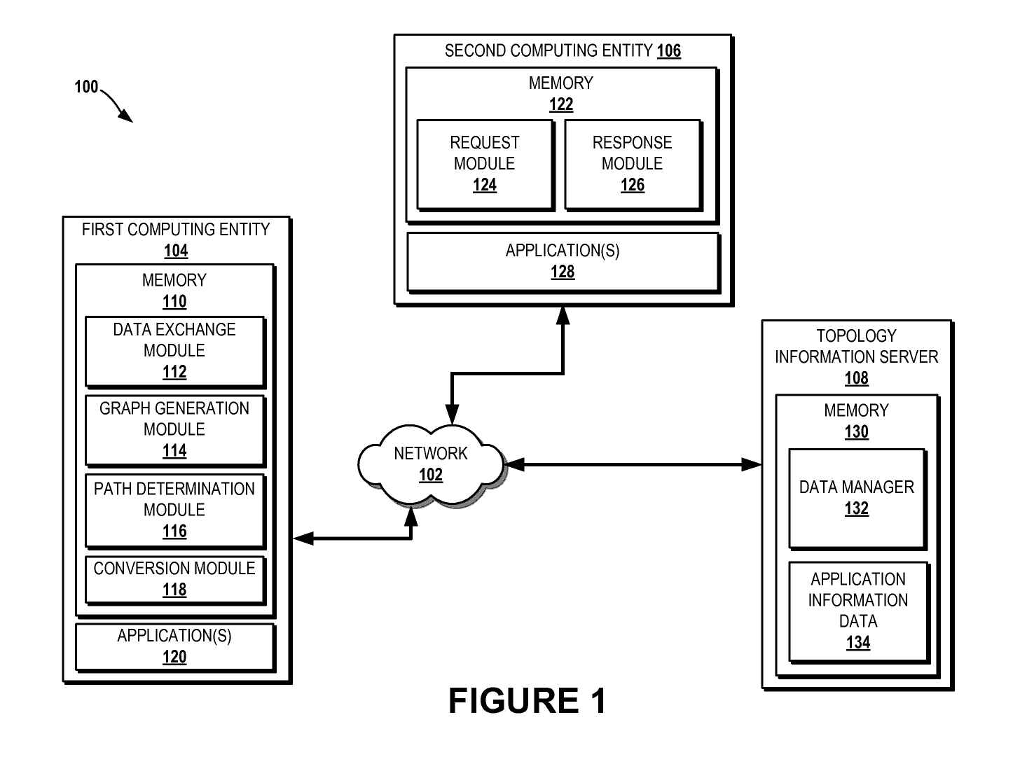

FIG. 1 is a block diagram showing several example components of a system for converting a data item into a new data format utilizing one or more applications. As described above, in some examples, applications can be executed by a single computing entity. In other examples, and as shown in FIG. 1, a system 100 can include a network 102, a first computing entity 104, a second computing entity 106, and a topology information server 108. Additional computing entities (not shown) can communicatively couple to the network 102, the first computing entity 104, the second computing entity 106, and/or the topology information server 108. In some examples, the topology information server 108 can be integral to the first computing entity 104, the second computing entity 106, or one of the additional computing entities (not shown). In other examples, the topology information server 108 can be communicatively coupled to the first computing entity 104, the second computing entity 106, and/or additional computing entities (not shown) via one or more local and/or wide area networks, such as the network 102. As described below, in some examples, the system 100 can include more than one topology information server 108 and each topology information server 108 can correspond to a group of computing entities that are associated with particular scopes.

The first computing entity 104 and/or the second computing entity 106 can represent computing entities that can execute applications (e.g., application(s) 120 or application(s) 128, respectively). In some examples, the first computing entity 104 and/or the second computing entity 106 can be user devices, for example, such as a laptop computer, a desktop computer, a smartphone, a tablet computing device or any other computing device, communicatively connected to the second computing entity 106 or the first computing entity 104, respectively, and the topology information server 108 through one or more local and/or wide area networks, such as the network 102. In other examples, the first computing entity 104 and/or the second computing entity 106 can be a server, a server cluster, a network accessible collection of server computers that provide various types of network services (e.g., a cloud), etc. communicatively connected to the second computing entity 106 or the first computing entity 104, respectively, and the topology information server 108 through one or more local and/or wide area networks, such as the network 102. It should be appreciated that many more network connections can be utilized than illustrated in FIG. 1.

The first computing entity 104 can include a local memory 110 that can include one or more modules and data structures, such as the data exchange module 112, the graph generation module 114, the path determination module 116, the conversion module 118, etc. The one or more modules and data structures can be configured to manage interactions between the first computing entity 104, the second computing entity 106, the topology information server 108, etc. The one or more modules and data structures can be in the form of stand-alone applications, productivity applications, an operating system component or any other application or software module having features that facilitate interactions between the first computing entity 104, the second computing entity 106, the topology information server 108, etc.

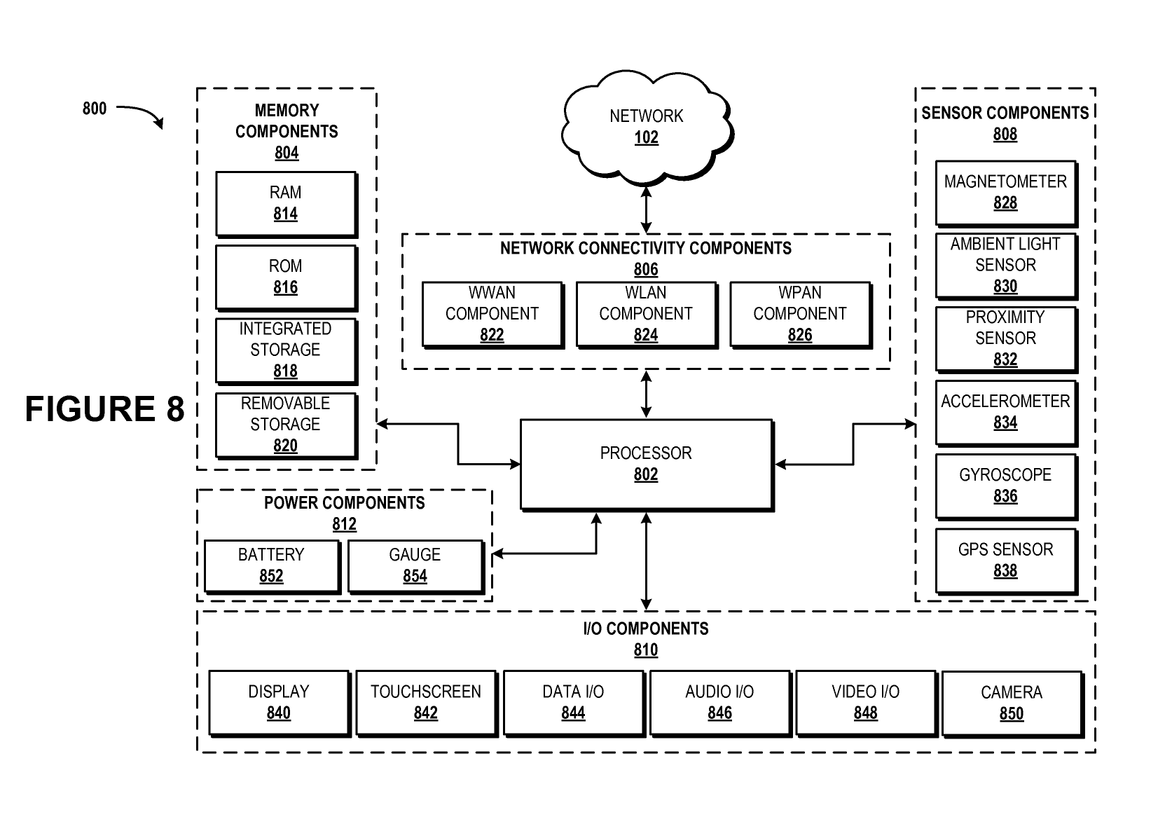

Additionally, the first computing entity 104 can include application(s) 120, as described above. In at least one example, the application(s) 120 can facilitate converting a data item from a first data format to a second data format, as described above and below. In such examples, each application of the application(s) 120 can be associated with application information data indicating an input data format that the application can read, an output data format that the application can write, and a time associated with converting a data item from the input data format to the output data format. Additional modules and components of the first computing entity 104 are explained below and shown in FIG. 8.

As will be explained below, the data exchange module 112 can send and receive communications from the other computing entities (e.g., the second computing entity 106, etc.) and/or the topology information server 108. Non-limiting examples of the capabilities of data exchange module 112 can include sending application information data to the topology information server 108, accessing application information data from the topology information server 108, etc. In at least one example, the data exchange module 112 can send application information data corresponding to each of the applications (e.g., application(s) 120) associated with the first computing entity 104 to the topology information server 108. As described below, the topology information server 108 can send aggregated application information data associated with one or more applications associated with the first computing entity 104 and/or other computing entities (e.g., second computing entity 106, etc.) to the data exchange module 112.

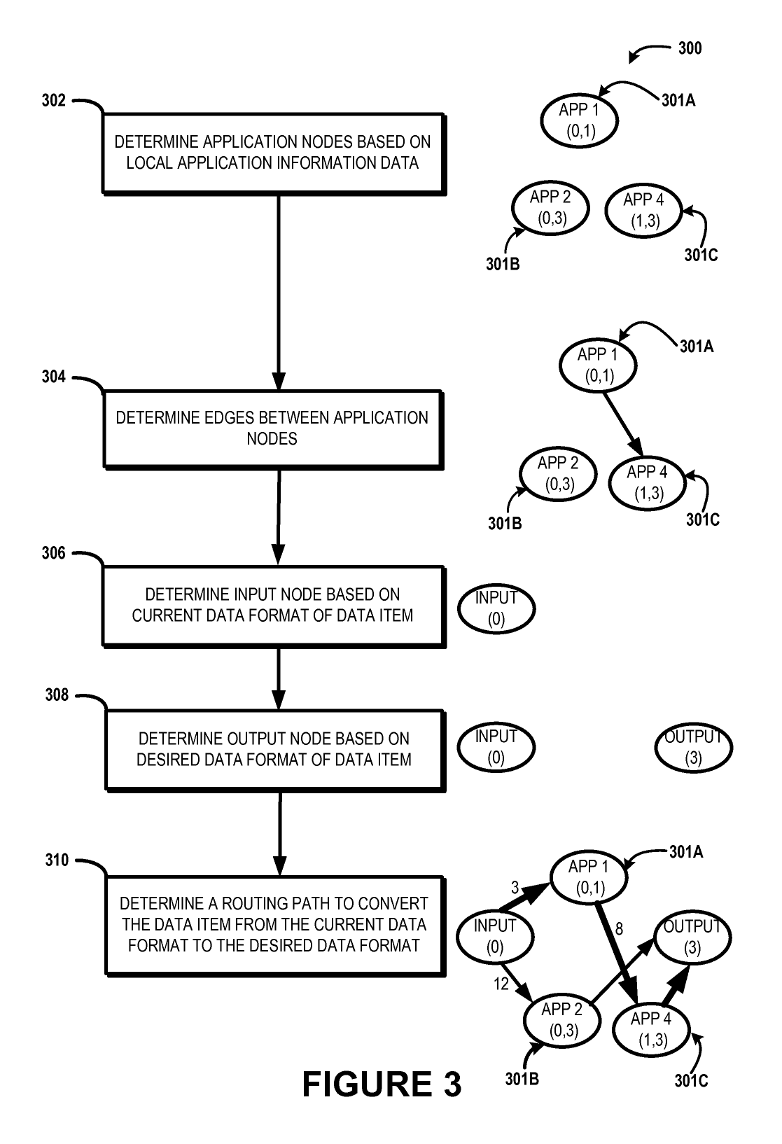

The graph generation module 114 can generate graphs including one or more routing paths for converting data items into new data formats. As described above, a routing path can include one or more applications (e.g., application(s) 120, application(s) 128, etc.) that can each be executed in succession to convert a data item from a current data format to a desired data format. In some examples, some of the applications (e.g., application(s) 120, application(s) 128, etc.) can be executed by different computing entities (e.g., first computing entity 104, second computing entity 106, etc.). In other examples, the applications (e.g., application(s) 120, application(s) 128, etc.) can be executed by a same, single computing entity (e.g., first computing entity 104, second computing entity 106, etc.). Additional details related to generating graphs are described below in FIG. 3.

The path determination module 116 can leverage the graphs generated by the graph generation module 114 to determine which routing path to perform to convert a data item from a current data format to a desired data format. In some examples, a user can select a routing path. In other examples, the path determination module 116 can select a routing path associated with a shortest total execution time (e.g., time required to perform the routing path) or a total execution time below a threshold time (e.g., based on raw execution time and ping-pong time), a routing path that consumes the least amount of computing resources, a routing path that corresponds to a routing path with the most throughput available, etc. In at least one example, the path determination module 116 can leverage various features to rank the individual routing paths. The features can include ping-pong time, server loading time, application execution time, etc., as described below. The path determination module 116 can recommend a highest ranking routing path to the user and/or select the highest ranking routing path for performance by the conversion module 118.

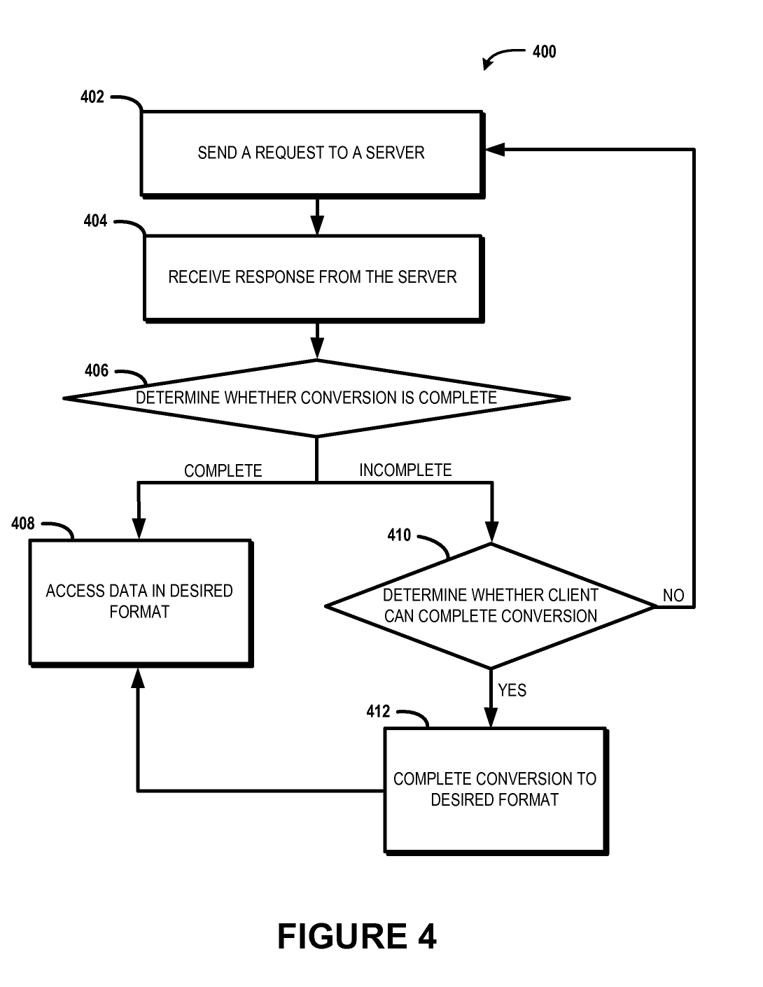

The conversion module 118 can facilitate the performance of the routing path. That is, the conversion module 118 can route requests to computing entities based at least in part on routing paths to convert data items into different data formats. In a first mode (i.e., requester mode), the conversion module 118 can send requests to other computing entities (e.g., second computing entity 106, etc.) and can receive responses from the other computing entities (e.g., second computing entity 106, etc.). The requests can include the data item and a request to convert the data item from a first data format to a second data format. The responses can include the data item in a converted data format (e.g., an intermediate data format or the desired data format). The conversion module 118 can determine whether each response includes the data item in the desired data format, and if not, the conversion module 118 can send subsequent requests to applications associated with the first computing entity 104 and/or send subsequent requests to other computing entities (e.g., second computing entity 106, etc.). The conversion module 118 can receive subsequent responses from the other computing entities (e.g., second computing entity 106, etc.). That is, the conversion module 118 can facilitate the performance of the routing path one application at a time to convert the data item from the current data format to the desired data format. Additional details related to performing the routing path in the requester mode are described below in FIG. 4.

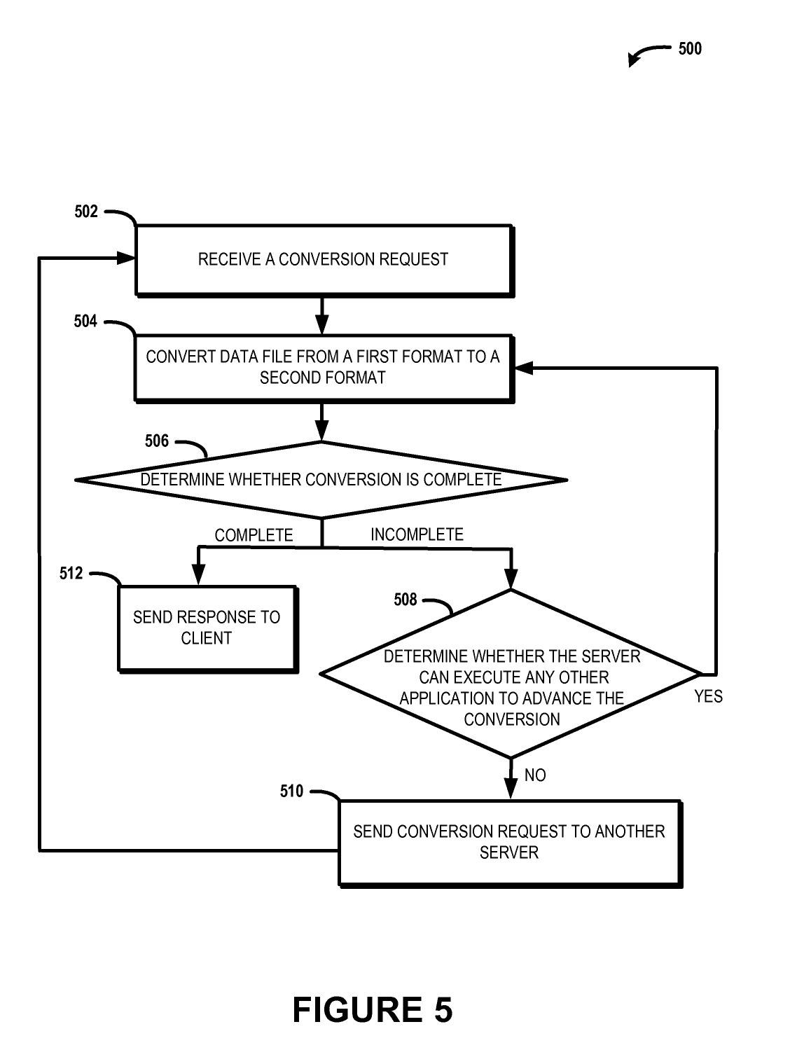

In a second mode (i.e., server mode), the conversion module 118 can send requests to other computing entities (e.g., second computing entity 106, etc.) and can receive a response from one of the other computing entities (e.g., second computing entity 106, etc.) that includes the data item in the desired format. That is, the conversion module 118 can initiate the performance of the routing path and the other computing entities (e.g., second computing entity 106, etc.) can facilitate successively routing requests to one application at a time to convert the data item from the current data format to the desired data format. Additional details related to performing the routing path in the server mode are described below in FIG. 5.

The second computing entity 106 can include a local memory 122 that can include one or more modules and data structures, such as the request module 124, the response module 126, etc. The one or more modules and data structures can be configured to manage interactions between the first computing entity 104, the second computing entity 106, the topology information server 108, etc. The one or more modules and data structures can be in the form of stand-alone applications, productivity applications, an operating system component or any other application or software module having features that facilitate interactions between the first computing entity 104, the second computing entity 106, the topology information server 108, etc. Additionally, the second computing entity 106 can execute application(s) 128. In at least one example, the application(s) 128 can facilitate converting a data item into a new data format, as described above and below. In such examples, each application of the application(s) 128 can be associated with an input data format that the application can read, an output data format that the application can write, and a time associated with converting a data item from the input data format to the output data format.

The request module 124 can send and/or receive requests. The requests can be associated with a data item and can specify a conversion of the data format of the data item from a first data format to a second data format. In some examples, the first data format can be the current data format. In other examples, the first data format can be an intermediate data format that is not the current data format or the desired data format. Similarly, in some examples, the second data format can be an intermediate data format and in other examples, the second data format can be the desired data format. The response module 126 can send and/or receive responses. The responses can include data items in converted data formats.

The topology information server 108 can be in the form of a server computer or a number of server computers configured to send and receive communications from the first computing entity 104 and/or the second computing entity 106. In some examples, the topology information server 108 can be associated with a computing entity or group of computing entities associated with a particular level of application access permissions based at least in part on a scope associated with the computing entity or group of computing entities. For the purposes of this discussion, scopes can include a global scope, a private scope, a cluster scope, or a personal scope. As described above, individual topology information servers 108 can each be associated with a different scope. In at least one example, in order to export an application to a particular scope, the computing entity seeking to export the application (e.g., first computing entity 104 and/or the second computing entity 106) can upload and/or download application information data, as described below, from a topology information server 108 corresponding to the particular scope. For instance, if a computing entity seeking to export an application (e.g., first computing entity 104 and/or the second computing entity 106) desires to access applications associated with global scope (e.g., worldwide), the computing entity seeking to export the application (e.g., first computing entity 104 and/or the second computing entity 106) can upload and/or download application information data from the topology information server 108 associated with the global scope.

The topology information server 108 can include a local memory 130 that can include one or more modules and data structures, such as a data manager 132, application information data 134, etc. The one or more modules and data structures can be configured to manage interactions between the first computing entity 104, the second computing entity 106, the topology information server 108, etc. The one or more modules and data structures can be in the form of stand-alone applications, productivity applications, an operating system component or any other application or software module having features that facilitate interactions between the first computing entity 104, the second computing entity 106, the topology information server 108, etc.

The data manager 132 can receive/access application information data from individual computing entities (e.g., first computing entity 104, second computing entity 106, etc.) and/or groups of computing entities associated with a particular level of application access permissions based at least in part on a scope associated with the individual computing entities or the configurations of computing entities. In at least one example, the individual computing entities and/or groups of computing entities can send application information data associated with an application based at least in part on identifying a new application on an individual computing device. The data manager 132 can aggregate the application information data associated with the individual applications and can send the aggregated application information data 134 to the individual computing entities (e.g., first computing entity 104, second computing entity 106, etc.). In additional and/or alternative examples, the individual computing entities (e.g., first computing entity 104, second computing entity 106, etc.) can access the aggregated application information data 134 from the data manager 132.

In at least one example, each application can be associated with a unique identifier and application information data associated with each application can correspond to the unique identifier. As described above, application information data can include at least an input data format each individual application is configured to read, an output data format each individual application is configured to write, and a time (e.g., total runtime) associated with converting individual data items from the input data format to the output data format. The time can be associated with a raw execution time for converting a data item from the input data format to the output data format and/or a ping-pong time associated with converting the data item from the input data format to the output data format. For the purposes of this discussion, ping-pong time refers to an amount of time that lapses in sending a request from an originating computing entity to a destination computing entity and the destination computing entity acknowledging the request back to the originating computing entity.

The application information data 134 can be stored in a table in the topology information server. Tables can correspond to aggregated application information data. The table can identify each application by the unique identifier associated with the application and the computing entity the application is associated with (e.g., first computing entity 104, second computing entity 106, etc.). In some examples, each application can additionally and/or alternatively be identified based on a particular computing device of the computing entities, if a computing entity includes more than one computing device. Additional information can be stored with the unique identifier, including, but not limited to, the input data format the corresponding application is capable of reading, the output data format the corresponding application is capable of writing, metrics associated with converting a data item from the input data format to the output data format (e.g., raw execution time, ping-pong time, total runtime, etc.). A non-limiting example table is included below in TABLE 1.

TABLE 1

| | Com- | Input | Output | Raw | Ping- | Total |
|---|---|---|---|---|---|---|
| | puting | Data | Data | Execution | pong | Run- |
| | Device | Format | Format | Time | Time | time |
| Application 1 | 1 | 0 | 1 | 1 | 2 | 3 |
| Application 2 | 2 | 0 | 3 | 10 | 2 | 12 |
| Application 3 | 3 | 2 | 4 | 5 | 2 | 7 |
| Application 4 | 2 | 1 | 3 | 3 | 5 | 8 |

In some examples, the data manager 132 can send the table to the individual computing entities (e.g., first computing entity 104, second computing entity 106, etc.) at predetermined frequencies, after a lapse of a predetermined period of time, etc. In other examples, the data manager 132 can send the table to the individual computing entities (e.g., first computing entity 104, second computing entity 106, etc.) responsive to triggering events, for example, the addition of a new computing device, identification of a new application, receipt of a new request to convert a data item into to a new data format, etc. In some examples, the data manager 132 can send the table to the data exchange module 112 responsive to a request from the data exchange module 112 to download the table. In other examples, the graph generation module 114 can access the data manager 132 and download the table. As described above, the data exchange module 112 can upload application information data to the data manager 132. In some examples, the application information data can be uploaded to the data manager 132 at a substantially same time as the table is downloaded.

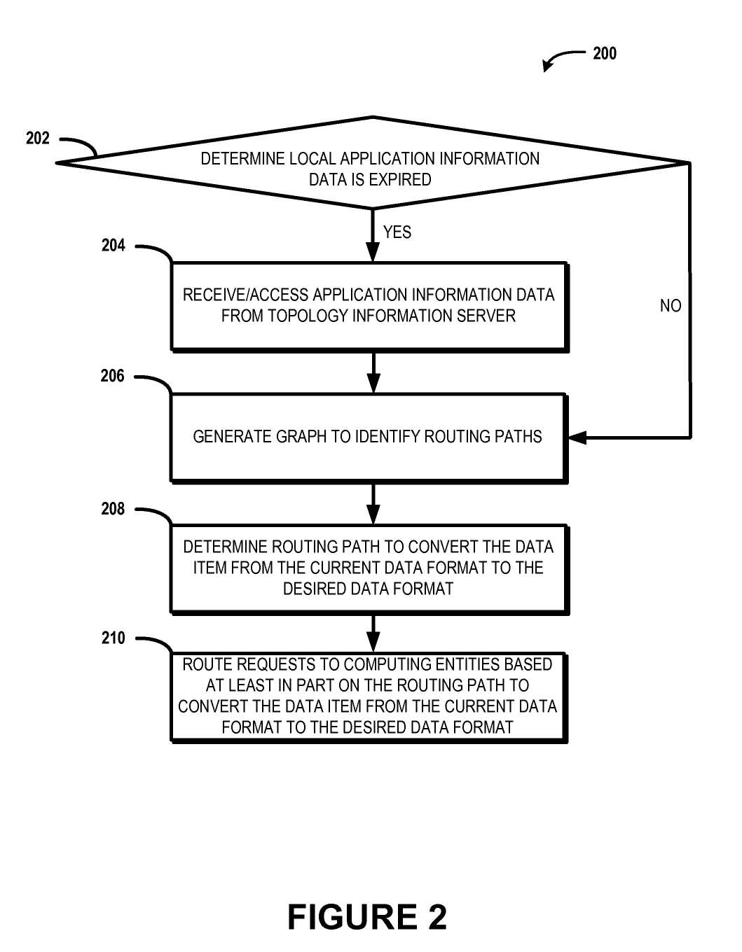

FIG. 2 is a flow diagram illustrating aspects of a method 200 for converting a data item into a new data format utilizing one or more applications. It should be appreciated that the logical operations described herein with respect to FIG. 2, and the other FIGURES, can be implemented (1) as a sequence of computer implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations can be performed than shown in the FIGURES and described herein. These operations can also be performed in parallel, or in a different order than those described herein. Some or all of these operations might also be performed by components other than those specifically identified.

Block 202 illustrates determining whether local application information data is expired. Local application information data is the aggregated application information data that the first computing entity 104 most recently downloaded. Table 1, described above, is a non-limiting example of aggregated application information data that can be received/accessed from the topology information server 108 by the data exchange module 112. In some examples, the local application information data can expire after a lapse of a predetermined period of time, the occurrence of an event (e.g., triggering events, for example, the addition of a new computing device), etc. If the local application information data is expired, the data exchange module 112 can request and subsequently receive updated application information data and/or can access the updated application information data. In some examples, the data exchange module 112 can receive and/or access the updated application information data based at least in part on receiving a new request to convert data formats of a data item and determining that the local application information data is expired.

Block 204 illustrates receiving/accessing application information data 134 from the topology information server 108. In examples where the local application information data is expired, the data exchange module 112 can receive/access aggregated application information data 134 from the topology information server 108. In some examples, the topology information server 108 can send aggregated application information data 134 associated with one or more applications (e.g., application(s) 120, application(s) 128, etc.) associated with other computing entities (e.g., second computing entity 106, etc.) to the data exchange module 112. As described above, the data manager 132 can send the aggregated application information data (e.g., Table 1, etc.) to the first computing entity 104 at predetermined frequencies, after a lapse of a predetermined period of time, etc. In other examples, the data manager 132 can send the aggregated application information data (e.g., Table 1, etc.) to the first computing entity 104 responsive to triggering events, for example, the addition of a new computing device, identification of a new application, request for updated application information data 134, receipt of a new request to convert a data item into a new data format, etc.

In additional and/or alternative examples, the data exchange module 112 can access the aggregated application information data (e.g., Table 1, etc.) and can download the aggregated application information data for generating the routing paths. In at least one example, the data exchange module 112 can access the aggregated application information data responsive to receiving a request to convert a data item from a current data format to a desired data format and determining that the local application information data is expired, as described above.

Block 206 illustrates generating a graph to identify routing paths for converting the data item from the current data format to the desired data format. The graph generation module 114 can generate graphs including one or more routing paths for converting data items into new data formats. The path determination module 116 can generate a graph based at least in part on the local application information data. In examples where the local application information data is not expired, the path determination module 116 may not need to access/receive updated application information data from the topology information server 108 to generate the graph. However, based at least in part on determining that the local application information data is expired, the data exchange module 112 can access/receive the aggregated application information data 134 from the topology information server 108.

FIG. 3 is a flow diagram illustrating aspects of a method 300 for generating a graph to determine a routing path for converting a data item from a current data format to a desired data format. For the purpose of discussion, the application nodes (e.g., 301A, 301B, 301C) illustrated in FIG. 3 correspond to the applications identified in TABLE 1, above.

The graph generation module 114 can access the local application information data (e.g., Table 1, etc.) to generate a base graph. The base graph can be leveraged for determining routing paths so long as the local application information data is not expired.

Block 302 illustrates determining application nodes based on local application information data. The graph generation module 114 can generate application nodes corresponding to applications identified in the local application information data. Application nodes are represented in FIG. 3 as nodes 301A, 301B, and 301C.

Block 304 illustrates determining edges between application nodes. As described above, each application can be associated with application information data indicating a data input that the application is configured to read (i.e., input) and a data input the application is configured to write (i.e., output). The graph generation module 114 can determine edges between application nodes representative of applications that are configured to read data that is a same data format as data output from another application. In at least one example, the weight of the edge can be based on a variety of features, including but not limited to, ping-pong time, server loading time, application execution time, etc., as described below. The graph generation module 114 can determine the edge without considering which computing entity an application is associated with. The base graph can be used until the graph generation module 114 determines that the local application information data is expired.

As described above, the graph generation module 114 can determine routing paths via the actions represented by blocks 306-310 below based on the base graph so long as the local application information data is not expired. Based at least in part on determining that the local application information data is expired, the data exchange module 112 can access and/or receive updated aggregated application information data 134. Based at least in part on receiving updated aggregated application information data 134, the graph generation module 114 can generate a new base graph and can leverage the new base graph for performing the actions represented by blocks 306-310 below until the updated aggregated application information data 134 expires.

Block 306 illustrates determining an input node based on a current data format of a data item. The graph generation module 114 can access the data item and determine the current data format of the data item. The graph generation module 114 can determine an input node corresponding to the current data format. In FIG. 3, the current data format is (0), as illustrated in the input node corresponding to block 302. As a non-limiting example, (0) can correspond to a MICROSOFT® WORD® data format (e.g., .doc, .docx) associated with a data item.

Block 308 illustrates determining an output node based on a desired data format of the data item. The graph generation module 114 can determine the desired data format of the data item. In some examples, the desired data format can be input based on user interaction with the first computing entity 104. The graph generation module 114 can determine an output node corresponding to the desired data format. In FIG. 3, the desired data format is (3), as illustrated in the output node corresponding to block 304. As a non-limiting example, (3) can correspond to a PDF data format (e.g., .pdf).

Block 310 illustrates determining a routing path to convert the data item from the current data format to the desired data format.

In at least one example, the graph generation module 114 can leverage a path algorithm (e.g., Depth-first search (DFS), Dijkstras algorithm, Ford-Fulkerson algorithm, other recursive or iterative algorithms for finding paths between two given nodes, etc.) to determine the various routing paths between the input node and the output node. The various applications can be associated with a single computing entity or multiple computing entities.

Based at least in part on determining the input node and/or the output node, the graph generation module 114 can leverage the base graph corresponding to the local application information data to determine a routing path for converting the data item from the current data format to the desired data format. The graph generation module 114 can access the base graph associated with the local application information data to determine each edge between the input node and any application node (e.g., 301A, 301B, 301C) that can read the data format corresponding to the input. The graph generation module 114 can determine the edge without considering which computing entity an application is associated with.

In FIG. 3, the graph generation module 114 determined an edge from the input node to the application node 301A corresponding to Application 1 (APP 1) and the application node 301B corresponding to Application 2 (APP 2). Pursuant to the application information data received from the topology information server 108, Application 1 and Application 2 are configured to read data having a data format of (0). Application 3 (not shown) and Application 4 (APP 4) are configured to read data having different data formats (2) and (1), respectively), and accordingly, the graph generation module 114 did not determine an edge between the input node and application nodes corresponding to Application 3 (not shown) and Application 4 301C.

Additionally, the graph generation module 114 can determine an edge from each application node (e.g., 301A, 301B) to at least one of another application node (e.g., 301C) or the output node based at least in part on the output associated with each application node (e.g., 301A, 301B). The graph generation module 114 can access the base graph associated with the local application information data to determine each edge. In some examples, a data item can be converted from a current data format to a desired data format via execution of a single application. That is, a single application can be configured to read the current data format and to write the desired data format. In such examples, no intermediate data format is necessary to effectuate the conversion. Furthermore, in such examples, the graph generation module 114 can determine an edge between the application node (e.g., 301B) corresponding to the application that is configured to convert the data item from the current data format to the desired data format to the output node. In at least one example, the weight of the edge can be based on a variety of factors, as described above. In FIG. 3, Application 2 is configured to convert the data item from the current data format (0) to the desired data format (3). Accordingly, the graph generation module 114 can determine an edge between the application node 301B corresponding to Application 2 and the output node, as shown in the graph corresponding to block 310.

In other examples, more than one application can be required to convert a data item from the current data format to the desired data format. In such examples, a first application can convert a data item from the current data format to an intermediate data format that is not the current data format or the desired data format. Then, a second application can be executed to convert the data item in the intermediate data format to the desired data format. In additional and/or alternative examples, the second application can instead convert the data item from a first intermediate data format to a second intermediate data format. In such examples, a third application can be executed to convert the data item from the second intermediate data format to the desired data format. Additional intermediate data formats and applications can be executed to effectuate the conversion. Each application can correspond to an application node (e.g., 301A, 301B, 301C). As described above, in some examples, one or more intermediate data formats can be output and, accordingly, one or more applications can be leveraged to convert the one or more intermediate data formats to the desired data format.

In FIG. 3, Application 1 is configured to convert a data item in the current data format (0) to an intermediate data format (1). Application 4 is configured to convert the data item from the intermediate data format (1) to the desired data format (3). Accordingly, the graph generation module 114 can determine an edge between the application node 301A corresponding to Application 1 and the application node 301C corresponding to Application 4. Additionally, the graph generation module 114 can determine an edge between the application node 301C corresponding to Application 4 and the output node, as shown in the graph corresponding to block 310.

Each path created from the edges connecting the input node to one or more application nodes (e.g., 301A, 301B, 301C) and to the output node corresponds to a routing path. The graph generation module 114 can generate various routing paths, as described above. The path determination module 116 can determine which routing path to perform for converting the data item from a current data format to a desired data format. In some examples, a user can select a routing path and in other examples, the path determination module 116 can select a routing path associated with a shortest total execution time or a total execution time below a threshold time (e.g., based on raw execution time and ping-pong time), a routing path that consumes the least amount of computing resources, a routing path that corresponds to a routing path with the most throughput available, etc. As described above, in some examples, the path determination module 116 can rank the routing paths and determine the routing path based on a highest ranking routing path.

In FIG. 3, the total execution time (e.g., total runtime) per TABLE 1 is shown in the graph corresponding to block 312. For instance, the total runtime for Application 1 to convert a data item from current data format (0) to intermediate data format (1) is 3 time units (e.g., milliseconds, seconds, etc.) and the total runtime for Application 4 to convert a data item from intermediate data format (1) to desired data format (3) is 8 time units. Accordingly, the total time associated with converting the data item from the current data format (0) to the desired data format (3) via Application 1 and Application 4 is 11 time units.

The total runtime for Application 2 to convert the data item from the current data format (0) to the desired data format (3) is 12 time units. In such an example, the path determination module 116 can choose the routing path utilizing Application 1 and Application 4 based at least in part on determining that the total runtime for converting the data item from the current data format to the desired data format is less than if Application 2 executes the conversion. The selected routing path is illustrated in FIG. 3 as a thick black line. Returning to FIG. 2, block 208 illustrates determining a routing path to convert the data item from the current data format to the desired data format, as described above.

Block 210 illustrates routing requests to computing entities (e.g., first computing entity 104, second computing entity 106, etc.) based at least in part on the routing path to convert the data item from the current data format to the desired data format. The conversion module 118 can facilitate the performance of the routing path. In some examples, the applications associated with a routing path can be executed by a single computing entity (e.g., first computing entity 104). In such examples, the conversion module 118 can facilitate the performance of the routing path in the single computing entity (e.g., first computing entity 104).

In other examples, the applications associated with the routing path can be executed by with more than one computing entity (e.g., first computing entity 104 and second computing entity 106), as illustrated in FIG. 1. In such examples, in a first mode (i.e., requester mode), the conversion module 118 can send requests to other computing entities (e.g., second computing entity 106, etc.) and can receive responses from the other computing entities (e.g., second computing entity 106, etc.).

The conversion module 118 can determine whether each response includes the data item in the desired data format, and if not, the conversion module 118 can send subsequent responses to applications associated with the first computing entity 104 or other computing entities (e.g., second computing entity 106, etc.) for executing additional applications for performing additional conversions. The conversion module 118 can receive subsequent responses from the first computing entity 104 or other computing entities (e.g., second computing entity 106, etc.) including the data item in intermediate data formats or the desired data format. That is, the conversion module 118 can facilitate the performance of the routing path one application at a time to convert the data item from the current data format to the desired data format.

Alternatively, in such examples, in a second mode (i.e., server mode) the conversion module 118 can send requests to other computing entities (e.g., second computing entity 106, etc.) and each of the other computing entities (e.g., second computing entity 106, etc.) can send subsequent requests to other computing entities for performing the conversion. The computing entity associated with the application that performs the last conversion (e.g., from an intermediate data format to the desired data format) can send a final response to the first computing entity 104, the final response including the data item in the desired data format. In some examples, the first computing entity 104, can be associated with the application that performs the last conversion (e.g., from an intermediate data format to the desired data format). In such examples, the first computing entity 104 can simply access the data item in the desired data format after the conversion is complete. FIG. 4 and FIG. 5, described below, illustrate aspects of various methods for performing the routing path to convert the data item from the current data format to the desired data format.

FIG. 4 is a flow diagram illustrating aspects of a method 400 for performing a routing path to convert a data item into a new data format in a first mode (i.e., requester mode). For the purposes of the discussion of FIG. 4 and FIG. 5, the client corresponds to the first computing entity 104 and the servers correspond to other computing entities, such as the second computing entity 106. However, in additional and/or alternative examples, the client can correspond to the first computing entity 104, the second computing entity 106, or a computing entity not pictured and/or the servers can correspond to can correspond to the first computing entity 104, the second computing entity 106, or a computing entity not pictured.

Block 402 illustrates sending a request to a server (e.g., second computing entity 106). As described above, the conversion module 118 associated with a client (e.g., first computing entity 104) can send requests to servers (e.g., second computing entity 106, etc.). The request can include the data item and a request to convert a data item from the current data format to an intermediate data format or from the current data format to the desired data format (i.e., from a current data format to a new data format).

Block 404 illustrates receiving a response from the server (e.g., second computing entity 106). The conversion module 118 can receive responses from the servers (e.g., second computing entity 106, etc.). The response can include the data item in an intermediate data format or the desired data format.

Block 406 illustrates determining whether the conversion is complete. The conversion module 118 can determine whether each response includes the data item in the desired data format. Based at least in part on determining that the conversion is complete, the client (e.g., first computing entity 104) can access the data item in the desired data format as illustrated in block 408. Based at least in part on determining that the conversion is incomplete, the conversion module 118 can determine whether the client (e.g., the first computing entity 104) can complete the conversion. That is, the conversion module 118 can determine whether an application associated with the client (e.g., the first computing entity 104) can complete the conversion.

Based at least in part on determining that an application associated with the client (e.g., the first computing entity 104) can complete the conversion, the client (e.g., the first computing entity 104) can send the data item to the application, and execute the application to complete the conversion as illustrated in block 412. The client (e.g., first computing entity 104) can access the data item in the desired data format as illustrated in block 408.

Based at least in part on determining that the client (e.g., the first computing entity 104) cannot complete the conversion, the conversion module 118 can send subsequent requests to other servers (e.g., second computing entity 106, etc.). That is, based at least in part on determining that the client (e.g., the first computing entity 104) cannot complete the conversion, the conversion module 118 can repeat method 400 until the conversion is complete. The conversion module 118 can leverage the routing path determined from the graph for determining which server to send each subsequent request.

FIG. 5 is a flow diagram illustrating aspects of a method 500 for performing a routing path to convert a data item into a new data format in a second mode (i.e., server mode). Block 502 illustrates receiving a request at a server (e.g., second computing entity 106). As described above, the request module 124 associated with the server (e.g., second computing entity 106) can receive requests from a client (e.g., first computing entity 104). The request can include a request for the server (e.g., second computing entity 106) to convert a data item from the current data format to an intermediate data format or from the current data format to the desired data format (i.e., to a new data format).

Block 504 illustrates converting a data file from a first data format to a second data format. The first data format can correspond to the current data format or to an intermediate data format and the second data format can correspond to an intermediate data format or the desired data format. An application (e.g., application(s) 128) associated with the server (e.g., second computing entity 106) can execute the conversion from the first data format to the second data format.

Block 506 illustrates determining whether the conversion is complete. That is, the response module 126 can determine whether the second data format corresponds to the desired data format. Based at least in part on determining that the second data format does not correspond to the desired data format, the response module 126 can determine that the conversion is incomplete and can then determine whether the server (e.g., second computing entity 106) can execute any other applications (e.g., application(s) 128) to advance and/or complete the conversion, as illustrated in block 508. Based at least in part on determining that the server (e.g., second computing entity 106) cannot execute any other applications (e.g., application(s) 128) to advance and/or complete the conversion, the request module 124 can send a new request to another server and the method 500 can repeat until the conversion is complete.

Block 510 illustrates sending a request to another server. Based at least in part on determining that the server (e.g., second computing entity 106) can execute another application (e.g., application(s) 128) to advance and/or complete the conversion, the server can execute the other application (e.g., application(s) 128) to convert the data file from a first data format to a second data format.

Based at least in part on determining that the second data format corresponds to the desired data format, the response module 126 can determine that the conversion is complete and can send a response to the client (e.g., first computing entity 104), as illustrated in block 512. The response can include the data item in the desired data format.

FIG. 6 shows additional details of an example computer architecture 600 for a computer, such as first computing entity 104, second computing entity 106, and/or topology information server 108 (FIG. 1), capable of executing the program components described above for converting a data item into a new data format. Thus, the computer architecture 600 illustrated in FIG. 6 illustrates an architecture for a server computer, mobile phone, a PDA, a smart phone, a desktop computer, a netbook computer, a tablet computer, and/or a laptop computer. The computer architecture 600 can be utilized to execute any aspects of the software components presented herein.

The computer architecture 600 illustrated in FIG. 6 includes a central processing unit 602 (“CPU”), a system memory 604, including a random access memory 606 (“RAM”) and a read-only memory (“ROM”) 606, and a system bus 610 that couples the memory 604 to the CPU 602. A basic input/output system containing the basic routines that help to transfer information between elements within the computer architecture 600, such as during startup, is stored in the ROM 606. The computer architecture 600 further includes a mass storage device 612 for storing an operating system 607, and one or more application programs including but not limited to the data exchange module 112, graph generation module 114, path determination module 116, conversion module 118, etc.

The mass storage device 612 is connected to the CPU 602 through a mass storage controller (not shown) connected to the bus 610. The mass storage device 612 and its associated computer-readable media provide non-volatile storage for the computer architecture 600. Although the description of computer-readable media contained herein refers to a mass storage device, such as a solid state drive, a hard disk or CD-ROM drive, it should be appreciated by those skilled in the art that computer-readable media can be any available computer storage media or communication media that can be accessed by the computer architecture 600.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media can include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 600. For purposes the claims, the phrase “computer storage medium,” “computer-readable storage medium” and variations thereof, does not include waves, signals, and/or other transitory and/or intangible communication media, per se.

According to various configurations, the computer architecture 600 can operate in a networked environment using logical connections to remote computers through the network 102 and/or another network (not shown). The computer architecture 600 can connect to the network 102 through a network interface unit 614 connected to the bus 610. It should be appreciated that the network interface unit 614 also can be utilized to connect to other types of networks and remote computer systems. The computer architecture 600 also can include an input/output controller 616 for receiving and processing input from a number of other devices, including a keyboard, mouse, or electronic stylus (not shown in FIG. 6). Similarly, the input/output controller 616 can provide output to a display screen, a printer, or other type of output device (also not shown in FIG. 6).

It should be appreciated that the software components described herein can, when loaded into the CPU 602 and executed, transform the CPU 602 and the overall computer architecture 600 from a general-purpose computing system into a special-purpose computing system customized to facilitate the functionality presented herein. The CPU 602 can be constructed from any number of transistors or other discrete circuit elements, which can individually or collectively assume any number of states. More specifically, the CPU 602 can operate as a finite-state machine, in response to executable instructions contained within the software modules disclosed herein. These computer-executable instructions can transform the CPU 602 by specifying how the CPU 602 transitions between states, thereby transforming the transistors or other discrete hardware elements constituting the CPU 602.

Encoding the software modules presented herein also can transform the physical structure of the computer-readable media presented herein. The specific transformation of physical structure can depend on various factors, in different implementations of this description. Examples of such factors can include, but are not limited to, the technology used to implement the computer-readable media, whether the computer-readable media is characterized as primary or secondary storage, and the like. For example, if the computer-readable media is implemented as semiconductor-based memory, the software disclosed herein can be encoded on the computer-readable media by transforming the physical state of the semiconductor memory. For example, the software can transform the state of transistors, capacitors, or other discrete circuit elements constituting the semiconductor memory. The software also can transform the physical state of such components in order to store data thereupon.

As another example, the computer-readable media disclosed herein can be implemented using magnetic or optical technology. In such implementations, the software presented herein can transform the physical state of magnetic or optical media, when the software is encoded therein. These transformations can include altering the magnetic characteristics of particular locations within given magnetic media. These transformations also can include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 600 in order to store and execute the software components presented herein. It also should be appreciated that the computer architecture 600 can include other types of computing entities, including hand-held computers, embedded computer systems, personal digital assistants, and other types of computing entities known to those skilled in the art. It is also contemplated that the computer architecture 600 might not include all of the components shown in FIG. 6, can include other components that are not explicitly shown in FIG. 6, or can utilize an architecture completely different than that shown in FIG. 6.

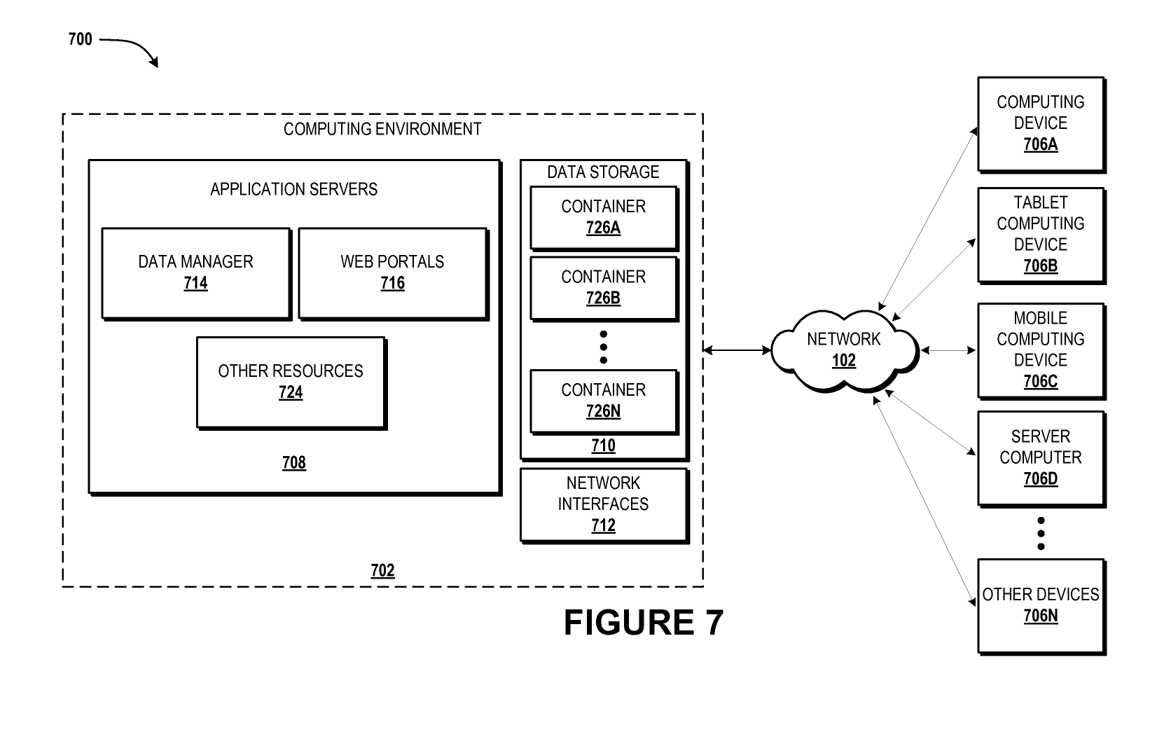

FIG. 7 depicts an illustrative distributed computing environment 700 capable of executing the software components described herein for providing application autorouting for converting a data item into a new data format. Thus, the distributed computing environment 700 illustrated in FIG. 7 can be utilized to execute any aspects of the software components presented herein. For example, the distributed computing environment 700 can be utilized to execute aspects of the data exchange module 112, graph generation module 114, path determination module 116, conversion module 118, associated with the first computing entity 104 and/or other software components described herein, such as the modules and/or applications associated with the second computing entity 106 and/or the topology information server 108.

According to various implementations, the distributed computing environment 700 includes a computing environment 702 operating on, in communication with, or as part of the network 102. The network 102 can be or can include the network 102, described above with reference to FIG. 6. The network 102 also can include various access networks. One or more client devices 706A-706N (hereinafter referred to collectively and/or generically as “clients 706”) can communicate with the computing environment 702 via the network 102 and/or other connections (not illustrated in FIG. 7). In one illustrated configuration, the clients 706 include a computing device 706A such as a laptop computer, a desktop computer, or other computing device; a slate or tablet computing device (“tablet computing device”) 706B; a mobile computing device 706C such as a mobile telephone, a smart phone, or other mobile computing device; a server computer 706D; and/or other devices 706N. It should be understood that any number of clients 706 can communicate with the computing environment 702. Two example computing architectures for the clients 706 are illustrated and described herein with reference to FIGS. 6 and 8. It should be understood that the illustrated clients 706 and computing architectures illustrated and described herein are illustrative, and should not be construed as being limited in any way.

In the illustrated configuration, the computing environment 702 includes application servers 708, data storage 710, and one or more network interfaces 712. According to various implementations, the functionality of the application servers 708 can be provided by one or more server computers that are executing as part of, or in communication with, the network 102. The application servers 708 can host various services, virtual machines, portals, and/or other resources. In the illustrated configuration, the application servers 708 can host one or more virtual machines for executing applications or other functionality. According to various implementations, the virtual machines can execute one or more applications and/or software modules for providing application autorouting for converting a data item into new data formats. It should be understood that this configuration is illustrative, and should not be construed as being limiting in any way. The application servers 708 also host or provide access to one or more portals, link pages, Web sites, and/or other information (“Web portals”) 716. The Web portals 716 can be used to communicate with one or more client computer.

As shown in FIG. 7, the application servers 708 also can host other services, applications, portals, and/or other resources (“other resources”) 724. The other resources 724 can deploy a service-oriented architecture or any other client-server management software. It thus can be appreciated that the computing environment 702 can provide integration of the concepts and technologies disclosed herein provided herein with various mailbox, messaging, social networking, and/or other services or resources.

As mentioned above, the computing environment 702 can include the data storage 710. According to various implementations, the functionality of the data storage 710 is provided by one or more databases operating on, or in communication with, the network 102. The functionality of the data storage 710 also can be provided by one or more server computers configured to host data for the computing environment 702. The data storage 710 can include, host, or provide one or more real or virtual containers 726A-726N (hereinafter referred to collectively and/or generically as “containers 726”). The containers 726, which can be used to form a key container 131 or a secret container 115, are configured to host data used or created by the application servers 708 and/or other data. Although not illustrated in FIG. 7, the containers 726 also can host or store data structures and/or algorithms for execution by a module, such as the data exchange module 112, graph generation module 114, path determination module 116, conversion module 118, etc. Aspects of the containers 726 can be associated with a database program, file system and/or any program that stores data with secure access features. Aspects of the containers 726 can also be implemented using products or services, such as ACTIVE DIRECTORY, DKM, ONEDRIVE, DROPBOX or GOOGLEDRIVE.

The computing environment 702 can communicate with, or be accessed by, the network interfaces 712. The network interfaces 712 can include various types of network hardware and software for supporting communications between two or more computing entities including, but not limited to, the clients 706 and the application servers 708. It should be appreciated that the network interfaces 712 also can be utilized to connect to other types of networks and/or computer systems.

It should be understood that the distributed computing environment 700 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 700 provides the software functionality described herein as a service to the clients 706. It should be understood that the clients 706 can include real or virtual machines including, but not limited to, server computers, web servers, personal computers, mobile computing entities, smart phones, and/or other devices. As such, various configurations of the concepts and technologies disclosed herein enable any device configured to access the distributed computing environment 700 to utilize the functionality described herein for providing application autorouting for converting data items into new data formats, among other aspects. In one specific example, as summarized above, techniques described herein can be implemented, at least in part, by a web browser application that can work in conjunction with the application servers 708 of FIG. 7.

Turning now to FIG. 8, an illustrative computing device architecture 800 for a computing device that is capable of executing various software components described herein for providing application autorouting to convert a data item into a new data format. The computing device architecture 800 is applicable to computing entities that facilitate mobile computing due, in part, to form factor, wireless connectivity, and/or battery-powered operation. In some configurations, the computing entities include, but are not limited to, mobile telephones, tablet devices, slate devices, portable video game devices, and the like. The computing device architecture 800 is applicable to any of the clients 706 shown in FIG. 7. In at least one example, individual of the clients can correspond to the first computing entity 104, the second computing entity 106, etc. Moreover, aspects of the computing device architecture 800 can be applicable to traditional desktop computers, portable computers (e.g., laptops, notebooks, ultra-portables, and netbooks), server computers, and other computer systems, such as described herein with reference to FIG. 6. In at least one example, the computing device architecture 800 can correspond to a topology information server 108. For example, the single touch and multi-touch aspects disclosed herein below can be applied to desktop computers that utilize a touchscreen or some other touch-enabled device, such as a touch-enabled track pad or touch-enabled mouse.

The computing device architecture 800 illustrated in FIG. 8 includes a processor 802, memory components 804, network connectivity components 806, sensor components 808, input/output components 810, and power components 812. In the illustrated configuration, the processor 802 is in communication with the memory components 804, the network connectivity components 806, the sensor components 808, the input/output (“I/O”) components 810, and the power components 812. Although no connections are shown between the individuals components illustrated in FIG. 8, the components can interact to carry out device functions. In some configurations, the components are arranged so as to communicate via one or more busses (not shown).

The processor 802 includes a central processing unit (“CPU”) configured to process data, execute computer-executable instructions of one or more application programs, and communicate with other components of the computing device architecture 800 in order to perform various functionality described herein. The processor 802 can be utilized to execute aspects of the software components presented herein and, particularly, those that utilize, at least in part, a touch-enabled input.

In some configurations, the processor 802 includes a graphics processing unit (“GPU”) configured to accelerate operations performed by the CPU, including, but not limited to, operations performed by executing general-purpose scientific and/or engineering computing applications, as well as graphics-intensive computing applications such as high resolution video (e.g., 720P, 1080P, and higher resolution), video games, three-dimensional (“3D”) modeling applications, and the like. In some configurations, the processor 802 is configured to communicate with a discrete GPU (not shown). In any case, the CPU and GPU can be configured in accordance with a co-processing CPU/GPU computing model, wherein the sequential part of an application executes on the CPU and the computationally-intensive part is accelerated by the GPU.

In some configurations, the processor 802 is, or is included in, a system-on-chip (“SoC”) along with one or more of the other components described herein below. For example, the SoC can include the processor 802, a GPU, one or more of the network connectivity components 806, and one or more of the sensor components 808. In some configurations, the processor 802 is fabricated, in part, utilizing a package-on-package (“PoP”) integrated circuit packaging technique. The processor 802 can be a single core or multi-core processor.

The processor 802 can be created in accordance with an ARM architecture, available for license from ARM HOLDINGS of Cambridge, United Kingdom. Alternatively, the processor 802 can be created in accordance with an x86 architecture, such as is available from INTEL CORPORATION of Mountain View, Calif. and others. In some configurations, the processor 802 is a SNAPDRAGON SoC, available from QUALCOMM of San Diego, Calif., a TEGRA SoC, available from NVIDIA of Santa Clara, Calif., a HUMMINGBIRD SoC, available from SAMSUNG of Seoul, South Korea, an Open Multimedia Application Platform (“OMAP”) SoC, available from TEXAS INSTRUMENTS of Dallas, Tex., a customized version of any of the above SoCs, or a proprietary SoC.

The memory components 804 include a random access memory (“RAM”) 814, a read-only memory (“ROM”) 816, an integrated storage memory (“integrated storage”) 818, and a removable storage memory (“removable storage”) 820. In some configurations, the RAM 814 or a portion thereof, the ROM 816 or a portion thereof, and/or some combination the RAM 814 and the ROM 816 is integrated in the processor 802. In some configurations, the ROM 816 is configured to store a firmware, an operating system or a portion thereof (e.g., operating system kernel), and/or a bootloader to load an operating system kernel from the integrated storage 818 and/or the removable storage 820.

The integrated storage 818 can include a solid-state memory, a hard disk, or a combination of solid-state memory and a hard disk. The integrated storage 818 can be soldered or otherwise connected to a logic board upon which the processor 802 and other components described herein also can be connected. As such, the integrated storage 818 is integrated in the computing device. The integrated storage 818 is configured to store an operating system or portions thereof, application programs, data, and other software components described herein.

The removable storage 820 can include a solid-state memory, a hard disk, or a combination of solid-state memory and a hard disk. In some configurations, the removable storage 820 is provided in lieu of the integrated storage 818. In other configurations, the removable storage 820 is provided as additional optional storage. In some configurations, the removable storage 820 is logically combined with the integrated storage 818 such that the total available storage is made available as a total combined storage capacity. In some configurations, the total combined capacity of the integrated storage 818 and the removable storage 820 is shown to a user instead of separate storage capacities for the integrated storage 818 and the removable storage 820.

The removable storage 820 is configured to be inserted into a removable storage memory slot (not shown) or other mechanism by which the removable storage 820 is inserted and secured to facilitate a connection over which the removable storage 820 can communicate with other components of the computing device, such as the processor 802. The removable storage 820 can be embodied in various memory card formats including, but not limited to, PC card, CompactFlash card, memory stick, secure digital (“SD”), miniSD, microSD, universal integrated circuit card (“UICC”) (e.g., a subscriber identity module (“SIM”) or universal SIM (“USIM”)), a proprietary format, or the like.

It can be understood that one or more of the memory components 804 can store an operating system. According to various configurations, the operating system includes, but is not limited to, SYMBIAN OS from SYMBIAN LIMITED, WINDOWS MOBILE OS from Microsoft Corporation of Redmond, Wash., WINDOWS PHONE OS from Microsoft Corporation, WINDOWS from Microsoft Corporation, PALM WEBOS from Hewlett-Packard Company of Palo Alto, Calif., BLACKBERRY OS from Research In Motion Limited of Waterloo, Ontario, Canada, IOS from Apple Inc. of Cupertino, Calif., and ANDROID OS from Google Inc. of Mountain View, Calif. Other operating systems are contemplated.

The network connectivity components 806 include a wireless wide area network component (“WWAN component”) 822, a wireless local area network component (“WLAN component”) 824, and a wireless personal area network component (“WPAN component”) 826. The network connectivity components 806 facilitate communications to and from the network 102 or another network, which can be a WWAN, a WLAN, or a WPAN. Although only the network 102 is illustrated, the network connectivity components 806 can facilitate simultaneous communication with multiple networks, including the network 102 of FIG. 7. For example, the network connectivity components 806 can facilitate simultaneous communications with multiple networks via one or more of a WWAN, a WLAN, or a WPAN.

The network 102 can be or can include a WWAN, such as a mobile telecommunications network utilizing one or more mobile telecommunications technologies to provide voice and/or data services to a computing device utilizing the computing device architecture 800 via the WWAN component 822. The mobile telecommunications technologies can include, but are not limited to, Global System for Mobile communications (“GSM”), Code Division Multiple Access (“CDMA”) ONE, CDMA2000, Universal Mobile Telecommunications System (“UMTS”), Long Term Evolution (“LTE”), and Worldwide Interoperability for Microwave Access (“WiMAX”). Moreover, the network 102 can utilize various channel access methods (which can or cannot be used by the aforementioned standards) including, but not limited to, Time Division Multiple Access (“TDMA”), Frequency Division Multiple Access (“FDMA”), CDMA, wideband CDMA (“W-CDMA”), Orthogonal Frequency Division Multiplexing (“OFDM”), Space Division Multiple Access (“SDMA”), and the like. Data communications can be provided using General Packet Radio Service (“GPRS”), Enhanced Data rates for Global Evolution (“EDGE”), the High-Speed Packet Access (“HSPA”) protocol family including High-Speed Downlink Packet Access (“HSDPA”), Enhanced Uplink (“EUL”) or otherwise termed High-Speed Uplink Packet Access (“HSUPA”), Evolved HSPA (“HSPA+”), LTE, and various other current and future wireless data access standards. The network 102 can be configured to provide voice and/or data communications with any combination of the above technologies. The network 102 can be configured to or adapted to provide voice and/or data communications in accordance with future generation technologies.

In some configurations, the WWAN component 822 is configured to provide dual-multi-mode connectivity to the network 102. For example, the WWAN component 822 can be configured to provide connectivity to the network 102, wherein the network 102 provides service via GSM and UMTS technologies, or via some other combination of technologies. Alternatively, multiple WWAN components 822 can be utilized to perform such functionality, and/or provide additional functionality to support other non-compatible technologies (i.e., incapable of being supported by a single WWAN component). The WWAN component 822 can facilitate similar connectivity to multiple networks (e.g., a UMTS network and an LTE network).

The network 102 can be a WLAN operating in accordance with one or more Institute of Electrical and Electronic Engineers (“IEEE”) 802.11 standards, such as IEEE 802.11a, 802.11b, 802.11g, 802.11n, and/or future 802.11 standard (referred to herein collectively as WI-FI). Draft 802.11 standards are also contemplated. In some configurations, the WLAN is implemented utilizing one or more wireless WI-FI access points. In some configurations, one or more of the wireless WI-FI access points are another computing device with connectivity to a WWAN that are functioning as a WI-FI hotspot. The WLAN component 824 is configured to connect to the network 102 via the WI-FI access points. Such connections can be secured via various encryption technologies including, but not limited, WI-FI Protected Access (“WPA”), WPA2, Wired Equivalent Privacy (“WEP”), and the like.

The network 102 can be a WPAN operating in accordance with Infrared Data Association (“IrDA”), BLUETOOTH, wireless Universal Serial Bus (“USB”), Z-Wave, ZIGBEE, or some other short-range wireless technology. In some configurations, the WPAN component 826 is configured to facilitate communications with other devices, such as peripherals, computers, or other computing entities via the WPAN.

The sensor components 808 include a magnetometer 828, an ambient light sensor 830, a proximity sensor 832, an accelerometer 834, a gyroscope 836, and a Global Positioning System sensor (“GPS sensor”) 838. It is contemplated that other sensors, such as, but not limited to, temperature sensors or shock detection sensors, also can be incorporated in the computing device architecture 800.

The magnetometer 828 is configured to measure the strength and direction of a magnetic field. In some configurations the magnetometer 828 provides measurements to a compass application program stored within one of the memory components 804 in order to provide a user with accurate directions in a frame of reference including the cardinal directions, north, south, east, and west. Similar measurements can be provided to a navigation application program that includes a compass component. Other uses of measurements obtained by the magnetometer 828 are contemplated.

The ambient light sensor 830 is configured to measure ambient light. In some configurations, the ambient light sensor 830 provides measurements to an application program stored within one the memory components 804 in order to automatically adjust the brightness of a display (described below) to compensate for low-light and high-light environments. Other uses of measurements obtained by the ambient light sensor 830 are contemplated.

The proximity sensor 832 is configured to detect the presence of an object or thing in proximity to the computing device without direct contact. In some configurations, the proximity sensor 832 detects the presence of a user's body (e.g., the user's face) and provides this information to an application program stored within one of the memory components 804 that utilizes the proximity information to enable or disable some functionality of the computing device. For example, a telephone application program can automatically disable a touchscreen (described below) in response to receiving the proximity information so that the user's face does not inadvertently end a call or enable/disable other functionality within the telephone application program during the call. Other uses of proximity as detected by the proximity sensor 828 are contemplated.

The accelerometer 834 is configured to measure proper acceleration. In some configurations, output from the accelerometer 834 is used by an application program as an input mechanism to control some functionality of the application program. For example, the application program can be a video game in which a character, a portion thereof, or an object is moved or otherwise manipulated in response to input received via the accelerometer 834. In some configurations, output from the accelerometer 834 is provided to an application program for use in switching between landscape and portrait modes, calculating coordinate acceleration, or detecting a fall. Other uses of the accelerometer 834 are contemplated.

The gyroscope 836 is configured to measure and maintain orientation. In some configurations, output from the gyroscope 836 is used by an application program as an input mechanism to control some functionality of the application program. For example, the gyroscope 836 can be used for accurate recognition of movement within a 3D environment of a video game application or some other application. In some configurations, an application program utilizes output from the gyroscope 836 and the accelerometer 834 to enhance control of some functionality of the application program. Other uses of the gyroscope 836 are contemplated.

The GPS sensor 838 is configured to receive signals from GPS satellites for use in calculating a location. The location calculated by the GPS sensor 838 can be used by any application program that requires or benefits from location information. For example, the location calculated by the GPS sensor 838 can be used with a navigation application program to provide directions from the location to a destination or directions from the destination to the location. Moreover, the GPS sensor 838 can be used to provide location information to an external location-based service, such as E911 service. The GPS sensor 838 can obtain location information generated via WI-FI, WIMAX, and/or cellular triangulation techniques utilizing one or more of the network connectivity components 806 to aid the GPS sensor 838 in obtaining a location fix. The GPS sensor 838 can also be used in Assisted GPS (“A-GPS”) systems.

The I/O components 810 include a display 840, a touchscreen 842, a data I/O interface component (“data I/O”) 844, an audio I/O interface component (“audio I/O”) 846, a video I/O interface component (“video I/O”) 848, and a camera 850. In some configurations, the display 840 and the touchscreen 842 are combined. In some configurations two or more of the data I/O component 844, the audio I/O component 846, and the video I/O component 848 are combined. The I/O components 810 can include discrete processors configured to support the various interface described below, or can include processing functionality built-in to the processor 802.

The display 840 is an output device configured to present information in a visual form. In particular, the display 840 can present graphical user interface (“GUI”) elements, text, images, video, notifications, virtual buttons, virtual keyboards, messaging data, Internet content, device status, time, date, calendar data, preferences, map information, location information, and any other information that is capable of being presented in a visual form. In some configurations, the display 840 is a liquid crystal display (“LCD”) utilizing any active or passive matrix technology and any backlighting technology (if used). In some configurations, the display 840 is an organic light emitting diode (“OLED”) display. Other display types are contemplated.

The touchscreen 842, also referred to herein as a “touch-enabled screen,” is an input device configured to detect the presence and location of a touch. The touchscreen 842 can be a resistive touchscreen, a capacitive touchscreen, a surface acoustic wave touchscreen, an infrared touchscreen, an optical imaging touchscreen, a dispersive signal touchscreen, an acoustic pulse recognition touchscreen, or can utilize any other touchscreen technology. In some configurations, the touchscreen 842 is incorporated on top of the display 840 as a transparent layer to enable a user to use one or more touches to interact with objects or other information presented on the display 840. In other configurations, the touchscreen 842 is a touch pad incorporated on a surface of the computing device that does not include the display 840. For example, the computing device can have a touchscreen incorporated on top of the display 840 and a touch pad on a surface opposite the display 840.

In some configurations, the touchscreen 842 is a single-touch touchscreen. In other configurations, the touchscreen 842 is a multi-touch touchscreen. In some configurations, the touchscreen 842 is configured to detect discrete touches, single touch gestures, and/or multi-touch gestures. These are collectively referred to herein as gestures for convenience. Several gestures will now be described. It should be understood that these gestures are illustrative and are not intended to limit the scope of the appended claims. Moreover, the described gestures, additional gestures, and/or alternative gestures can be implemented in software for use with the touchscreen 842. As such, a developer can create gestures that are specific to a particular application program.

In some configurations, the touchscreen 842 supports a tap gesture in which a user taps the touchscreen 842 once on an item presented on the display 840. The tap gesture can be used for various reasons including, but not limited to, opening or launching whatever the user taps. In some configurations, the touchscreen 842 supports a double tap gesture in which a user taps the touchscreen 842 twice on an item presented on the display 840. The double tap gesture can be used for various reasons including, but not limited to, zooming in or zooming out in stages. In some configurations, the touchscreen 842 supports a tap and hold gesture in which a user taps the touchscreen 842 and maintains contact for at least a pre-defined time. The tap and hold gesture can be used for various reasons including, but not limited to, opening a context-specific menu.

In some configurations, the touchscreen 842 supports a pan gesture in which a user places a finger on the touchscreen 842 and maintains contact with the touchscreen 842 while moving the finger on the touchscreen 842. The pan gesture can be used for various reasons including, but not limited to, moving through screens, images, or menus at a controlled rate. Multiple finger pan gestures are also contemplated. In some configurations, the touchscreen 842 supports a flick gesture in which a user swipes a finger in the direction the user wants the screen to move. The flick gesture can be used for various reasons including, but not limited to, scrolling horizontally or vertically through menus or pages. In some configurations, the touchscreen 842 supports a pinch and stretch gesture in which a user makes a pinching motion with two fingers (e.g., thumb and forefinger) on the touchscreen 842 or moves the two fingers apart. The pinch and stretch gesture can be used for various reasons including, but not limited to, zooming gradually in or out of a website, map, or picture.

Although the above gestures have been described with reference to the use one or more fingers for performing the gestures, other appendages such as toes or objects such as styluses can be used to interact with the touchscreen 842. As such, the above gestures should be understood as being illustrative and should not be construed as being limiting in any way.

The data I/O interface component 844 is configured to facilitate input of data to the computing device and output of data from the computing device. In some configurations, the data I/O interface component 844 includes a connector configured to provide wired connectivity between the computing device and a computer system, for example, for synchronization operation purposes. The connector can be a proprietary connector or a standardized connector such as USB, micro-USB, mini-USB, or the like. In some configurations, the connector is a dock connector for docking the computing device with another device such as a docking station, audio device (e.g., a digital music player), or video device.

The audio I/O interface component 846 is configured to provide audio input and/or output capabilities to the computing device. In some configurations, the audio I/O interface component 846 includes a microphone configured to collect audio signals. In some configurations, the audio I/O interface component 846 includes a headphone jack configured to provide connectivity for headphones or other external speakers. In some configurations, the audio I/O interface component 846 includes a speaker for the output of audio signals. In some configurations, the audio I/O interface component 846 includes an optical audio cable out.

The video I/O interface component 848 is configured to provide video input and/or output capabilities to the computing device. In some configurations, the video I/O interface component 848 includes a video connector configured to receive video as input from another device (e.g., a video media player such as a DVD or BLURAY player) or send video as output to another device (e.g., a monitor, a television, or some other external display). In some configurations, the video I/O interface component 848 includes a High-Definition Multimedia Interface (“HDMI”), mini-HDMI, micro-HDMI, DisplayPort, or proprietary connector to input/output video content. In some configurations, the video I/O interface component 848 or portions thereof is combined with the audio I/O interface component 846 or portions thereof.

The camera 850 can be configured to capture still images and/or video. The camera 850 can utilize a charge coupled device (“CCD”) or a complementary metal oxide semiconductor (“CMOS”) image sensor to capture images. In some configurations, the camera 850 includes a flash to aid in taking pictures in low-light environments. Settings for the camera 850 can be implemented as hardware or software buttons.

Although not illustrated, one or more hardware buttons can also be included in the computing device architecture 800. The hardware buttons can be used for controlling some operational aspect of the computing device. The hardware buttons can be dedicated buttons or multi-use buttons. The hardware buttons can be mechanical or sensor-based.

The illustrated power components 812 include one or more batteries 852, which can be connected to a battery gauge 854. The batteries 852 can be rechargeable or disposable. Rechargeable battery types include, but are not limited to, lithium polymer, lithium ion, nickel cadmium, and nickel metal hydride. Each of the batteries 852 can be made of one or more cells.

The battery gauge 854 can be configured to measure battery parameters such as current, voltage, and temperature. In some configurations, the battery gauge 854 is configured to measure the effect of a battery's discharge rate, temperature, age and other factors to predict remaining life within a certain percentage of error. In some configurations, the battery gauge 854 provides measurements to an application program that is configured to utilize the measurements to present useful power management data to a user. Power management data can include one or more of a percentage of battery used, a percentage of battery remaining, a battery condition, a remaining time, a remaining capacity (e.g., in watt hours), a current draw, and a voltage.

The power components 812 can also include a power connector, which can be combined with one or more of the aforementioned I/O components 810. The power components 812 can interface with an external power system or charging equipment via a power I/O component.

The disclosure presented herein can be considered in view of the following clauses.

A. A first computing entity, comprising: a processor; a computer-readable storage medium in communication with the processor, the computer-readable storage medium having computer-executable instructions stored thereupon which, when executed by the processor, cause the first computing entity to: access application information data from a topology information server communicatively coupled to the first computing entity, the application information data corresponding to applications associated with the first computing entity or individual second computing entities communicatively coupled to the topology information server; based at least in part on accessing the application information data, generate a graph comprising one or more routing paths associated with individual applications of the applications for converting a data item from a current data format to a desired data format; determine a routing path of the one or more routing paths for converting the data item from the current data format to the desired data format; and routing requests to at least one of the first computing entity and the individual second computing entities based at least in part on: sending a request to one of the individual second computing entities, the request including the data item and instructions specifying a conversion of the data item from the current data format to a new data format; and receiving a response to the request from the one of the individual second computing entities, the response including the data item in the new data format.

B. The first computing entity as paragraph A recites, wherein the application information data includes data indicating at least an input data format each individual application is configured to read, an output data format each individual application is configured to write, and a time associated with converting individual data items from the input data format to the output data format.

C. The first computing entity as any of paragraphs A or B recite, wherein generating the graph comprises: determining an input node corresponding to the current data format of the data item; determining an output node corresponding to the desired data format of the data item; determining a first edge from the input node to a first application node corresponding to an individual application configured to read data items in the current data format; and determining a second edge from the first application node to a second application node or the output node based at least in part on the output associated with the first application node.

D. The first computing entity as paragraph C recites, wherein: each routing path of the one or more routing paths comprises at least the input node, the output node, the first edge, and the second edge; and each routing path is associated with a time for converting the data item from the current data format to the desired data format.

E. The first computing entity as paragraph D recites, wherein determining the routing path is based at least in part on determining that the time associated with the routing path for converting the data item from the current data format to the desired data format is below a threshold time.

F. The first computing entity as paragraph C recites, wherein the first application node and the second application node are associated with different computing entities.

G. The first computing entity as any of paragraphs A-F recite, wherein the first computing entity is further configured to, based at least in part on receiving the response to the request, determine that the new data format is the desired data format.

H. The first computing entity as any of paragraphs A-G recite, wherein the first computing entity is further configured to: based at least in part on receiving the response to the request, determine that the new data format is an intermediate data format that is not the current data format or the desired data format; determine that one or more individual applications of the applications associated with the first computing entity are not configured to convert the data item from the intermediate data format to the desired data format; iteratively send subsequent requests to other individual second computing entities of the individual second computing entities; and iteratively receive subsequent responses to the subsequent requests from the other individual second computing entities.

I. The first computing entity as paragraph H recites, wherein the first computing entity is further configured to: determine that a subsequent response of the subsequent responses includes the data item in the desired data format; and terminate the iteratively sending of the subsequent requests to the other individual second computing entities.

J. The first computing entity as any of paragraphs A-I recite, wherein the first computing entity is further configured to: based at least in part on receiving the response to the request, determine that the new data format is an intermediate data format that is not the current data format or the desired data format; determine that one or more individual applications of the applications associated with the first computing entity are configured to convert the data item from the intermediate data format to the desired data format; and execute an application of the one or more individual applications to convert the data item from the intermediate data format to the desired data format.

K. A system comprising: a topology information server configured to store aggregated application information data associated with individual computing entities; a first individual computing entity of the individual computing entities configured to: access the aggregated application information data; and determine, based at least in part on the aggregated application information data, a routing path for converting a data item from a current data format to a desired data format; and a second individual computing entity of the individual computing entities configured to: receive a first communication from the first individual computing entity comprising the data item and a first request to convert the data item from the current data format to a new data format; and execute a first application to convert the data item from the current data format to the new data format.

L. The system as paragraph K recites, wherein the topology information server is further configured to: receive application information data from the individual computing entities, the application information data including at least an input data format an individual application associated with an individual computing entity of the individual computing entities is configured to read, an output data format the individual application is configured to write, and a time associated with converting individual data items from the input data format to the output data format; aggregate the application information data received from the individual computing entities to generate the aggregated application information data; and send the aggregated application information data to the individual computing resources at a predetermined frequency or based at least in part on an occurrence of a triggering event.

M. The system as any of paragraphs K or L recite, wherein the first individual computing entity determines a routing path based at least in part on constructing a graph comprising a plurality of routing paths for converting the data item from the current data format to the desired data format via two or more applications each associated with different individual computing entities of the individual computing entities.

N. The system as any of paragraphs K-M recite, wherein the second individual computing entity is further configured to: determine that the new data format is not the desired data format; based at least in part on determining that the new data format is not the desired data format, determine that the second individual computing entity is not configured to convert the data item from the new data format to the desired data format; and send a second communication to the first individual computing entity or a third individual computing entity of the individual computing entities comprising the data item and a second request to convert the data item from the new data format to the desired data format.

O. The system as any of paragraphs K-N recite, further comprising a third individual computing entity of the individual computing entities, the third individual computing entity configured to: receive a second communication from the second individual computing entity comprising a second request to convert the data item from the new data format to the desired data format; execute a second application to convert the data item from the new data format to the desired data format; and send a third communication to the first computing entity, the third communication comprising the data item in the desired data format.

P. A computer-implemented method for converting a data item from a current format to a desired format, the computer-implemented method comprising computer-implemented operations for: accessing application information data associated with a plurality of applications; determining, based at least in part on the application information data, one or more applications of the plurality of applications that, based at least in part on executing the one or more applications in succession, convert the data item from the current data format to the desired data format; sending the data item and a first request to a first application of the one or more applications to convert the data item from the current data format to a new data format; and receiving, a first response to the first request, the first response including the data item in the new data format.

Q. The computer-implemented method as paragraph P recites, wherein the new data format comprises the desired data format.

R. The computer-implemented method as any of paragraphs P or Q recite, wherein: the new data format comprises an intermediate data format between the current data format and the desired data format; and the computer-implemented method further comprises computer-implemented operations for: sending a second request to a second application of the one or more applications to convert the data item from the intermediate data format to the desired data format; and receiving, a second response to the second request, the second response including the data item in the desired data format.

S. The computer-implemented method as paragraph R recites, wherein the first application is associated with a first computing entity and the second application is associated with a second computing entity.

T. The computer-implemented method as any of paragraphs P-S recite, wherein: the new data format comprises a first intermediate data format between the current data format and the desired data format; and the computer-implemented method further comprises computer-implemented operations for: sending a second request to a second application of the one or more applications to convert the data item from the first intermediate data format to a second intermediate data format; receiving, a second response to the second request, the second response including the data item in the second intermediate data format; sending subsequent requests to other applications of the one or more applications to convert the data item into the desired data format; and receiving a subsequent response to a subsequent request of the subsequent requests, the subsequent response including the data item in the desired data format.

U. One or more computer-readable media encoded with instructions that, when executed by a processor, configure a computer to perform a method as any of paragraphs P-T recite.

V. A device comprising one or more processors and one or more computer readable media encoded with instructions that, when executed by the one or more processors, configure a computer to perform a computer-implemented method as recited in any of paragraphs P-T.

W. A computer-implemented method for converting a data item from a current format to a desired format, the computer-implemented method comprising computer-implemented operations including: means for accessing application information data associated with a plurality of applications; means for determining, based at least in part on the application information data, one or more applications of the plurality of applications that, based at least in part on executing the one or more applications in succession, convert the data item from the current data format to the desired data format; means for sending the data item and a first request to a first application of the one or more applications to convert the data item from the current data format to a new data format; and means for receiving, a first response to the first request, the first response including the data item in the new data format.

X. The computer-implemented method as paragraph W recites, wherein the new data format comprises the desired data format.

Y. The computer-implemented method as any of paragraphs W or X recite, wherein: the new data format comprises an intermediate data format between the current data format and the desired data format; and the computer-implemented method further comprises computer-implemented operations including: means for sending a second request to a second application of the one or more applications to convert the data item from the intermediate data format to the desired data format; and means for receiving, a second response to the second request, the second response including the data item in the desired data format.

Z. The computer-implemented method as paragraph Y recites, wherein the first application is associated with a first computing entity and the second application is associated with a second computing entity.

AA. The computer-implemented method as any of paragraphs W-Z recite, wherein: the new data format comprises a first intermediate data format between the current data format and the desired data format; and the computer-implemented method further comprises computer-implemented operations including: means for sending a second request to a second application of the one or more applications to convert the data item from the first intermediate data format to a second intermediate data format; means for receiving, a second response to the second request, the second response including the data item in the second intermediate data format; sending subsequent requests to other applications of the one or more applications to convert the data item into the desired data format; and means for receiving a subsequent response to a subsequent request of the subsequent requests, the subsequent response including the data item in the desired data format.

Based on the foregoing, it should be appreciated that concepts and technologies have been disclosed herein that provide application autorouting for converting data items into new data formats. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes can be made to the subject matter described herein without following the example configurations and applications illustrated and described, and without departing from the true spirit and scope of the present invention, which is set forth in the following claims.

What is claimed is:

1. A first computing entity, comprising:
a processor;
a computer-readable storage medium in communication with the processor, the computer-readable storage medium having computer-executable instructions stored thereupon which, when executed by the processor, cause the first computing entity to:
access application information data from a topology information server communicatively coupled to the first computing entity, the application information data corresponding to applications associated with the first computing entity or individual second computing entities communicatively coupled to the topology information server;
based at least in part on accessing the application information data, generate a graph comprising one or more routing paths associated with individual applications of the applications for converting a data item from a current data format to a desired data format;
determine a routing path of the one or more routing paths for converting the data item from the current data format to the desired data format; and
routing requests to at least one of the first computing entity and the individual second computing entities based at least in part on:
sending a request to one of the individual second computing entities, the request including the data item and instructions specifying a conversion of the data item from the current data format to a new data format; and
receiving a response to the request from the one of the individual second computing entities, the response including the data item in the new data format.

2. The first computing entity as claim 1 recites, wherein the application information data includes data indicating at least an input data format each individual application is configured to read, an output data format each individual application is configured to write, and a time associated with converting individual data items from the input data format to the output data format.

3. The first computing entity as claim 1 recites, wherein generating the graph comprises:
determining an input node corresponding to the current data format of the data item;
determining an output node corresponding to the desired data format of the data item;
determining a first edge from the input node to a first application node corresponding to an individual application configured to read data items in the current data format; and
determining a second edge from the first application node to a second application node or the output node based at least in part on the output associated with the first application node.

4. The first computing entity as claim 3 recites, wherein:
each routing path of the one or more routing paths comprises at least the input node, the output node, the first edge, and the second edge; and
each routing path is associated with a time for converting the data item from the current data format to the desired data format.

5. The first computing entity as claim 4 recites, wherein determining the routing path is based at least in part on determining that the time associated with the routing path for converting the data item from the current data format to the desired data format is below a threshold time.

6. The first computing entity as claim 3 recites, wherein the first application node and the second application node are associated with different computing entities.

7. The first computing entity as claim 1 recites, wherein the first computing entity is further configured to, based at least in part on receiving the response to the request, determine that the new data format is the desired data format.

8. The first computing entity as claim 1 recites, wherein the first computing entity is further configured to:
based at least in part on receiving the response to the request, determine that the new data format is an intermediate data format that is not the current data format or the desired data format;
determine that one or more individual applications of the applications associated with the first computing entity are not configured to convert the data item from the intermediate data format to the desired data format;
iteratively send subsequent requests to other individual second computing entities of the individual second computing entities; and
iteratively receive subsequent responses to the subsequent requests from the other individual second computing entities.

9. The first computing entity as claim 8 recites, wherein the first computing entity is further configured to:
determine that a subsequent response of the subsequent responses includes the data item in the desired data format; and
terminate the iteratively sending of the subsequent requests to the other individual second computing entities.

10. The first computing entity as claim 1 recites, wherein the first computing entity is further configured to:
based at least in part on receiving the response to the request, determine that the new data format is an intermediate data format that is not the current data format or the desired data format;
determine that one or more individual applications of the applications associated with the first computing entity are configured to convert the data item from the intermediate data format to the desired data format; and
execute an application of the one or more individual applications to convert the data item from the intermediate data format to the desired data format.

11. A system comprising:
a topology information server configured to store aggregated application information data associated with individual computing entities;
a first individual computing entity of the individual computing entities configured to:
access the aggregated application information data; and
determine, based at least in part on the aggregated application information data, a routing path for converting a data item from a current data format to a desired data format; and
a second individual computing entity of the individual computing entities configured to:
receive a first communication from the first individual computing entity comprising the data item and a first request to convert the data item from the current data format to a new data format; and
execute a first application to convert the data item from the current data format to the new data format.

12. The system as claim 11 recites, wherein the topology information server is further configured to:
receive application information data from the individual computing entities, the application information data including at least an input data format an individual application associated with an individual computing entity of the individual computing entities is configured to read, an output data format the individual application is configured to write, and a time associated with converting individual data items from the input data format to the output data format;
aggregate the application information data received from the individual computing entities to generate the aggregated application information data; and
send the aggregated application information data to the individual computing resources at a predetermined frequency or based at least in part on an occurrence of a triggering event.

13. The system as claim 11 recites, wherein the first individual computing entity determines a routing path based at least in part on constructing a graph comprising a plurality of routing paths for converting the data item from the current data format to the desired data format via two or more applications each associated with different individual computing entities of the individual computing entities.

14. The system as claim 11 recites, wherein the second individual computing entity is further configured to:
determine that the new data format is not the desired data format;
based at least in part on determining that the new data format is not the desired data format, determine that the second individual computing entity is not configured to convert the data item from the new data format to the desired data format; and
send a second communication to the first individual computing entity or a third individual computing entity of the individual computing entities comprising the data item and a second request to convert the data item from the new data format to the desired data format.

15. The system as claim 11 recites, further comprising a third individual computing entity of the individual computing entities, the third individual computing entity configured to:
receive a second communication from the second individual computing entity comprising a second request to convert the data item from the new data format to the desired data format;
execute a second application to convert the data item from the new data format to the desired data format; and
send a third communication to the first computing entity, the third communication comprising the data item in the desired data format.

16. A computer-implemented method for converting a data item from a current format to a desired format, the computer-implemented method comprising computer-implemented operations for:
accessing application information data associated with a plurality of applications;
determining, based at least in part on the application information data, one or more applications of the plurality of applications that, based at least in part on executing the one or more applications in succession, convert the data item from the current data format to the desired data format;
sending the data item and a first request to a first application of the one or more applications to convert the data item from the current data format to a new data format; and
receiving, a first response to the first request, the first response including the data item in the new data format.

17. The computer-implemented method as claim 16 recites, wherein the new data format comprises the desired data format.

18. The computer-implemented method as claim 16 recites, wherein:
the new data format comprises an intermediate data format between the current data format and the desired data format; and
the computer-implemented method further comprises computer-implemented operations for:
sending a second request to a second application of the one or more applications to convert the data item from the intermediate data format to the desired data format; and
receiving, a second response to the second request, the second response including the data item in the desired data format.

19. The computer-implemented method as claim 18 recites, wherein the first application is associated with a first computing entity and the second application is associated with a second computing entity.

20. The computer-implemented method as claim 16 recites, wherein:
the new data format comprises a first intermediate data format between the current data format and the desired data format; and
the computer-implemented method further comprises computer-implemented operations for:
sending a second request to a second application of the one or more applications to convert the data item from the first intermediate data format to a second intermediate data format;
receiving, a second response to the second request, the second response including the data item in the second intermediate data format;
sending subsequent requests to other applications of the one or more applications to convert the data item into the desired data format; and
receiving a subsequent response to a subsequent request of the subsequent requests, the subsequent response including the data item in the desired data format.
